(19) United States
(12) Patent Application Publication
(10) Pub. No.: US 2008/0177647 A1
(43) Pub. Date: Jul. 24, 2008

(54) Online Compliance Engine

(76) Inventor: John W. Veenstra, Holton, MI (US)

Correspondence Address: MERCHANT & GOULD PC, P.O. BOX 2903, MINNEAPOLIS, MN, 55402-0903, US

(21) Appl. No.: 12/015,293

(22) Filed: Jan. 16, 2008

Related U.S. Application Data
(60) Provisional application No. 60/881,426, filed on Jan. 19, 2007.

(51) Int. Cl. G06Q 30/00; G06F 15/16; G06F 21/24; G06F 7/06; G06F 17/30

(52) U.S. Cl. 705/34; 709/219; 726/6; 726/3; 707/3; 707/E17.014

(57) ABSTRACT

An online compliance engine stored on a computer readable storage medium includes an intercept module programmed to intercept a request by a client for content on a destination server, and a compliance module programmed to access and parse the content from the destination server requested by the client, and to determine whether or not the destination server is authorized to distribute the content, the compliance module being further programmed to allow the destination server to distribute the content to the client if the destination server is compliant, and to block the destination server from distributing the content if the destination server is not compliant. The engine also includes a billing module programmed to bill the destination server if the content is distributed to the client.

### RELATED APPLICATION

This application claims the benefit of U.S. Patent Provisional Application Ser. No. 60/881,426 filed on Jan. 19, 2007, the entirety of which is hereby incorporated by reference.

### BACKGROUND

The ubiquitous nature of the Internet and the ease at which electronic content is replicated allows for ready distribution of electronic content through the Internet. As more content such as documents, music and videos is made available for distribution online, it becomes more difficult for the owners of the intellectual property associated with the content to police the distribution and use of the content. Unscrupulous web site owners can distribute pirated content to thousands of users on the Internet in the matter of minutes. The intellectual property owners of such content have little ability to stop such piracy.

Further, the laws of various geographic areas can govern what content can be distributed to users located in those geographic areas. For examples, the governments of some countries have instituted laws censoring certain types of content from download by individuals located in those countries. Yet other governments have laws restricting export of certain content to certain other countries. Because of the open nature of the Internet, it is difficult for governmental entities to control the content that is distributed into and out of their respective geographic areas.

### SUMMARY

The present disclosure is directed to an online compliance engine that restricts the distribution of online content.

In one aspect, an online compliance engine stored on a computer readable storage medium includes an intercept module programmed to intercept a request by a client for content on a destination server, and a compliance module programmed to access and parse the content from the destination server requested by the client, and to determine whether or not the destination server is authorized to distribute the content, the compliance module being further programmed to allow the destination server to distribute the content to the client if the destination server is compliant, and to block the destination server from distributing the content if the destination server is not compliant. The engine also includes a billing module programmed to bill the destination server if the content is distributed to the client.

In another aspect, a method for controlling content distributed through a network includes: intercepting a request for content sent from a client to a server; accessing the content requested by the client; parsing the content to identify portions subject to restrictions on distribution; determining the server's compliance with distribution of the portions subject to restriction of distribution; allowing the server to distribute the content to the client if the server is compliant; and blocking the server from distributing the content to the client if the server is not compliant.

In yet another aspect, a method for controlling content distributed through the Internet includes: positioning a compliance and billing engine between a client and the Internet, the compliance and billing engine filtering all requests sent by the client through the Internet; intercepting a request for content sent from the client to a server; accessing the content requested by the client; parsing the content to identify portions subject to restrictions on distribution; determining the server's compliance with distribution of the portions subject to restriction of distribution based on intellectual property interests; allowing the server to distribute the content to the client if the server is compliant, and billing the server for the distribution of the content; and blocking the server from distributing the content to the client if the server is not compliant, and offering to license the server so that the server is compliant.

### DESCRIPTION OF THE DRAWINGS

FIG. 1 shows an example system including a client, a server, and an online compliance engine.

FIG. 2 shows the example online compliance engine of FIG. 1.

FIG. 3 shows an example method for restricting content distributed online.

FIG. 4 shows an example method for determining if a destination server is compliant.

FIG. 5 shows another example system including a client, a server, and an online compliance engine.

FIG. 6 shows yet another example system including a client, a server, and an online compliance engine.

### DETAILED DESCRIPTION

Reference will now be made in detail to the example aspects of the present disclosure that are illustrated in the accompanying drawings. Wherever possible, the same reference numbers will be used throughout the drawings to refer to the same or like structure.

In one example embodiment described herein, an online compliance engine is located between a user's browser and a destination website's server. The engine monitors, for example, the content that is sent from the destination website to the user and verifies whether the destination website is licensed to send the content. In one embodiment, if the destination website is not licensed, the engine sends a warning message to the user and offers to license the destination website. In another embodiment, if the destination website is licensed to send the content, the engine bills the destination website.

In alternative embodiments, the compliance and billing engine resides, for example, on a browser, at an Internet Service Provider (ISP), at a cellular phone provider, or the like. The engine filters user requests for wireless cells, web sites, searches, or the like for licensing data. The engine checks whether a requested web site, search site, cell provider, advertiser, or the like has a license to use the technology or to display the information requested by the user. In one embodiment, the requested information includes a geo-tagged advertisement or a geo-tagged search. In one embodiment, if the site does not have a license, the engine sends the user a message that the site cannot display the requested information and the engine invites the site to apply for a license. In another embodiment, if the site is licensed, the engine bills the site for the transaction.

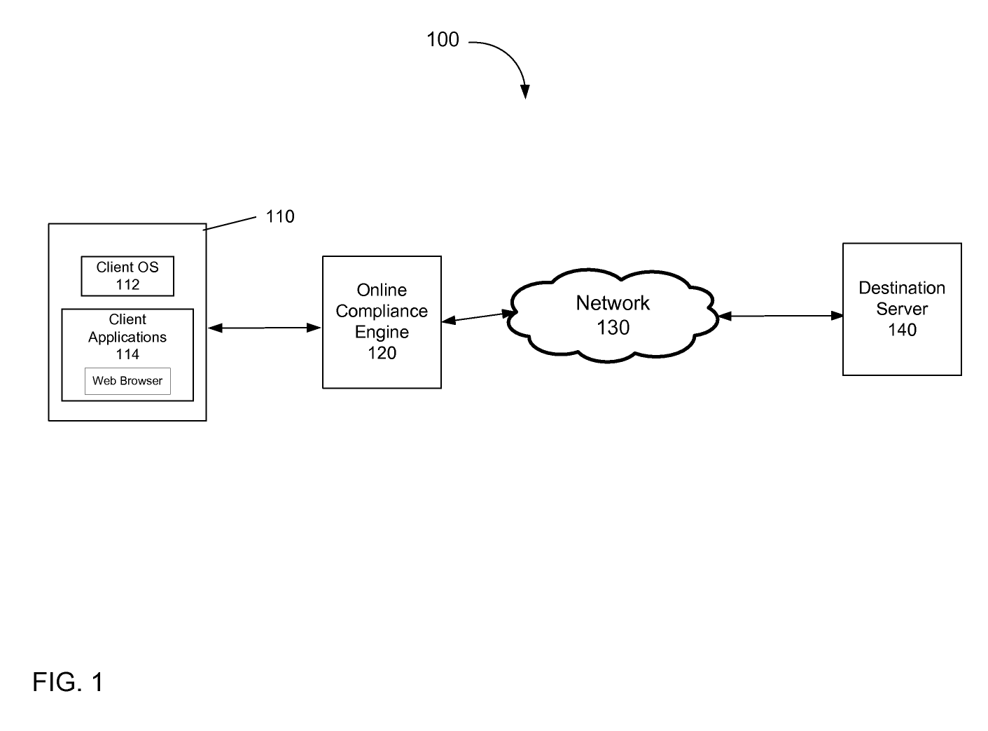

Referring now to FIG. 1, an example system 100 is shown. The system 100 includes a client computing system 110, an online compliance engine 120, a network 130, and a destination server 140.

In the example shown, the client computing system 110 is a computer system that is used to request content such as a webpage through a network such as the Internet. The client computing system 110 can be a desktop or laptop computer, a handheld or mobile device, a PocketPC, Smartphone, or Blackberry cellular device, or the like.

Typically, the client computing system 110 includes input/output devices, a central processing unit (“CPU”), one or more data storage devices, and a network device.

Input/output devices include, but are not limited to, keyboards, mice, displays, microphones, speakers, disk drives, CD-ROM drives, and flash drives. The input/output devices provide an interface between a user and the CPU. The user inputs commands and/or information into the input devices, which are then interpreted and processed by the CPU. Results or feedback from the CPU is then transmitted to the user through the output devices.

The data storage devices provide for data retention. The data storage devices can include computer readable media such as volatile (such as RAM), non-volatile (such as ROM, flash memory, etc.) or some combination thereof. Additionally, computer readable media can include mass storage (removable and/or non-removable) such as a magnetic or optical disks or tape. In the client computing system 110, the data storage devices are accessible by the CPU. Among the plurality of information stored on the data storage devices is a client operating system (“OS”) 112 and client applications 114.

The network device allows the client computing system 110 to send and receive data to/from a destination device through a network. One example of a typical network device is a network card or a modem such as a voiceband modem, DSL modem, or cable modem. Other configurations are possible.

The client OS 112 is a platform that manages the hardware and software resources of the client computing system 110. Some of the tasks performed by the client OS 112 include controlling and allocating memory resources, prioritizing system requests, controlling input and output devices, facilitating networking and managing file systems. The client OS 112 can include, but is not limited to, Microsoft Windows, Mac OS, Linux, Palm OS, and Symbian OS.

The client applications 114 utilize the resources of the client computing system 110 to perform tasks specified by the user. The client applications 114 can be business applications or personal applications. Some client applications 114 include, but are not limited to, word processors, spreadsheets, calendars, e-mail applications, and web browsers.

The user of the client computing system 110 can use an application such as a web browser to access content on a remote server using one or more protocols, such as the hypertext transport protocol (HTTP). Examples of such web browsers include Internet Explorer, Netscape, Safari, or Mozilla Firefox. In alternative embodiments, other applications and protocols can be used. For example, in one alternative, a file transport application can be used to access content using the file transport protocol (FTP). Other configurations are possible.

Referring still to FIG. 1, the client computing system 110 is used to access content that is available from the destination server 140 through the network 130, which can be a local area network or a wide area network. The network 130 can be implemented using wired and/or wireless technologies. For example, the network can be the Internet or a cellular network implemented using GSM or CDMA technologies.

In some examples, the content is data such as a document formatted according to the hypertext markup language (HTML). In other embodiments, the content can be other types of data, such as music, videos, documents created with one or more of the applications in the Microsoft Office suite, PDF documents, and/or other types of content available from destination servers on the network 130. In yet other examples, the content can be advertising.

The request created by the user of the client computing system 110 can take a variety of forms. The request can be for particular content like a file. In addition, the request can be a search request. Either type of request, as well as the requested content itself, can be tagged with additional information, such as geo-tagging that identifies geographic aspects of the request or content. Examples of systems generating these types of queries are described in U.S. Pat. No. 5,930,474 filed on Jan. 31, 1996, and U.S. Patent Provisional Application No. 60/957,904 filed on Aug. 24, 2007, the entireties of which are hereby incorporated by reference.

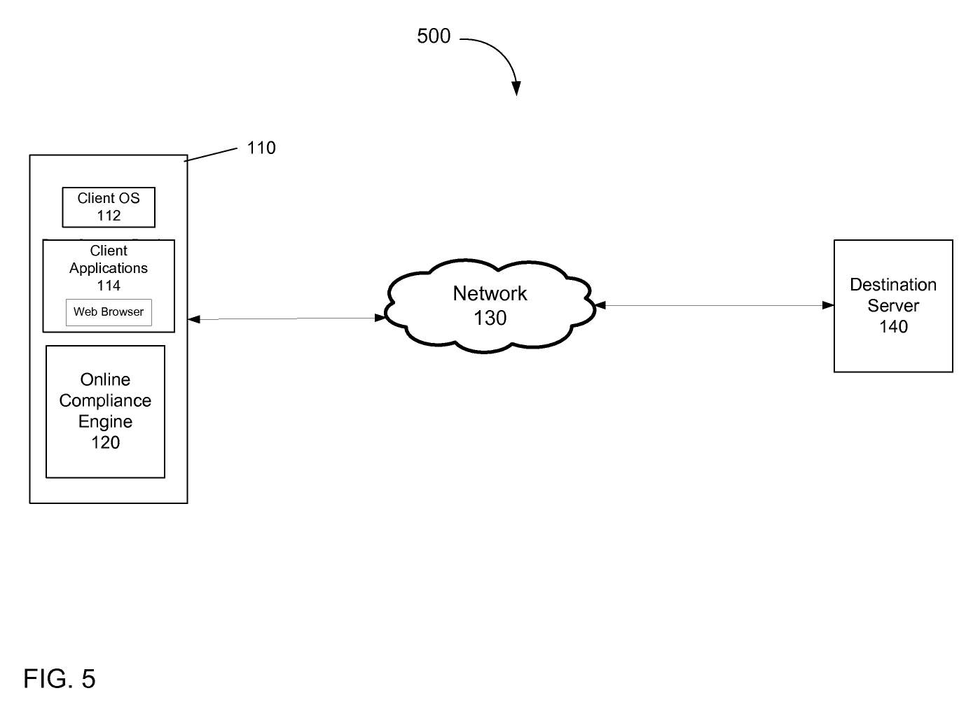

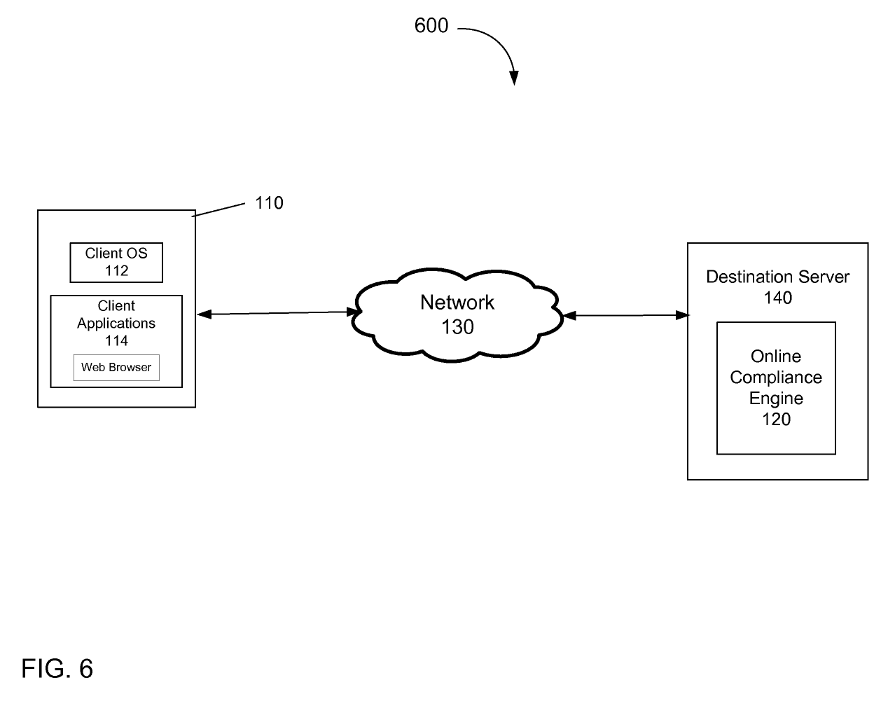

In the example shown, the online compliance engine 120 is positioned between the client computing system 110 and the network 130. As described further below, the online compliance engine 120 can perform such functions as monitoring, enforcing, reporting, and billing as the user of the client computing system 110 requests content from destination servers such as the destination server 140 through the network 130. The position of the online compliance engine 120 relative to the client computer system 110, the network 130, and the destination server 140 can be varied. For example, as described further below, in other embodiments, the online compliance engine 120 can be positioned at the client computing system 110 as part of the web browser, or can be positioned at the destination server 140. See FIGS. 5 and 6.

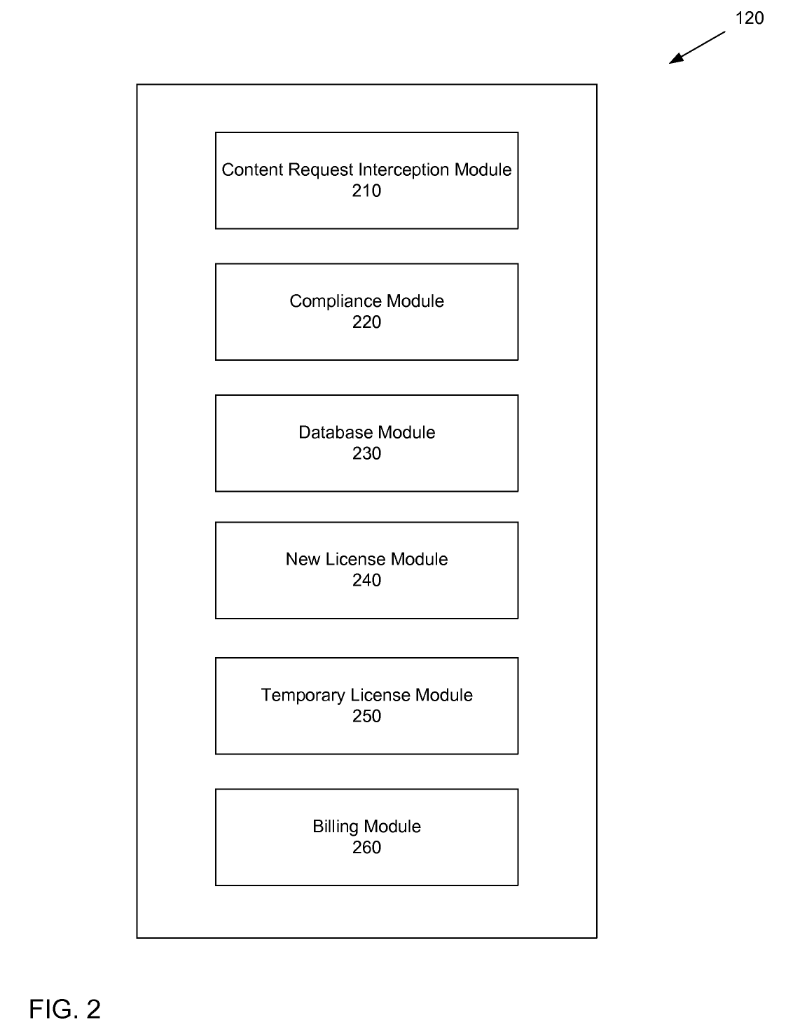

Referring now to FIG. 2, the online compliance engine 120 can be one or more computers that are in communication with the client computing system 110 and the network 130. The online compliance engine 120 includes a content request interception module 210, a compliance module 220, a database module 230, new license module 240, temporary license module 250, and a billing module 260. Generally, the online compliance engine 120 is programmed to intercept requests made by the client computing system 110, check for compliance with various rules, and take action based on the compliance, as described below.

The content request interception module 210 is programmed to intercept the request for content created at the client computing system 110. As shown, the online compliance engine 120 is located between the client computing system 110 and the network 130, so that the content request interception module 210 can intercept the request for content sent by the client computing system 110. In example embodiments, the online compliance engine 120 can be located at the local ISP, a regional ISP, or a national ISP associated with network access for the client computing system 110. As described below, other configurations are possible.

In the embodiment shown, the online compliance engine 120 functions like a domain name server (DNS). When the client computing system 110 requests the address for content hosted on a remote server such as the destination server 140, the content request interception module 210 intercepts that request.

Once intercepted, the compliance module 220 is programmed to perform one or more look-ups. For one of these look-ups, the compliance module 220 queries one or more databases to translate the domain name to the address (e.g., the IP address) of the requested remote server. This look-up process can involve querying of multiple databases including one or more of a local name server, a root name server, an intermediate name server, and/or an authoritative name server. In this manner, the compliance module 220 can function in a manner similar to a DNS.

In addition to the DNS-style look-up, the compliance module 220 can also be programmed to query the database module 230 to determine compliance with various rules. An example of such a query is to ask the database module 230 to determine if server hosting the content requested by the client computing system 110 is in compliance with various rules. As described further below, such rules can include compliance with intellectual property laws, compliance with other local laws, etc.

The database module 230 is a structured collection of information that is stored on one or more host servers. Information in database module 230 is retrieved using applications such as database management systems and/or information retrieval systems in response to queries. Database management systems manage and query databases, while information retrieval systems search documents, information in documents, metadata that describes documents, and databases. Examples of database management systems include, but are not limited to, Oracle, My SQL, PostgreSQL, DB2, Microsoft Access, and Microsoft SQL. Examples of information retrieval systems include, but are not limited to, search engines such as Google, Yahoo, AltaVista, and Ask.com.

In the example shown, the database module 230 is structured in a manner similar to that of the DNS system, in that the database module 230 can include a local compliance server, a root compliance server, an intermediate compliance server, and an authoritative compliance server. The local compliance server of the database module 230 caches compliance information for a period of time using regulated time to live (TTLs) strategy. If the look-up is not successful at the local compliance server (e.g., no information regarding the look-up has been cached at the local compliance server), the database module 230 is programmed to continue querying up the chain of compliance servers until the desired information is obtained. The distributed nature of the database module 230 can be advantageous to minimize bottle-necks during peak usage of the system 100. Other configurations are possible.

Referring still to FIG. 2, once the compliance module 220 has queried the database module 230, the compliance module 220 determines whether or not the requested content is in compliance with one or more rules.

In example embodiments, the compliance module 220 is programmed to automatically retrieve the requested content from the destination server 140 and analyze the content for compliance. This analysis can include checking of the content for compliance with intellectual property laws and other local government laws that may dictate the distribution and use of the content.

For example, the compliance module 220 is programmed to review the content from the destination server 140 to determine whether or not the destination server 140 has the proper licenses to distribute the content in view of one or more rights held by owners of the intellectual property associated with the content. In one example, the content is checked to determine whether or not the destination server 140 has the authority from the intellectual property holder (e.g., patent holder, copyright holder, or trademark holder) to distribute the content. As described above, the compliance module 220 can query the database module 230 to determine whether or not the destination server 140 has proper licenses from the intellectual property owner.

In some examples, the compliance module 220 caches compliance information related to content on various destination servers such as the destination server 140 so that the compliance module 220 need not perform look-ups in the database module 230 every time particular content is requested from a destination server. The compliance module 220 can periodically check the content offered by the destination server 140 and update the cache as appropriate with new compliance information.

In one example, the database schema of the database module 230 is programmed to store compliance data in a particular format for access by the compliance module 220. The database module 230 stores compliance information in look-up tables according to a hash value calculated using the IP address of the destination server 140. The schema includes the following information:

| Column Name | Description |
|---|---|
| HASH_VALUE | A hash value computed by |
| | applying the hash function to the |
| | destination server IP address or a |
| | hash value. |
| NEXT_COMPLIANCE_SERV- | If the compliance data is out-dated |
| ER_IP | or missing, this is the IP address of |
| | the next higher compliance server |
| | that may contain the compliance |
| | information. |
| IS_NEXT_COMPLIANCE_SERV- | A TRUE/FALSE value indicating |
| ER_AUTHORITATIVE | whether or not the next |
| | compliance server is authoritative. |

As described herein, the compliance information for a destination server can be cached at a particular compliance server for a pre-defined period of time. The example schema for such caching is provided below.

| Column Name | Description |
|---|---|
| DESTINATION_SERVER_IP | IP address of the destination server. |
| IS_COMPLIANT | TRUE/FALSE indicating whether |
| | or not the destination |
| | server is compliant. |
| COMPLIANCE_CHECK_TIME | The time when the compliance |
| | check was performed. |

As described herein, the COMPLIANCE_CHECK_TIME value can be used to age the cached information and periodically require updates to the cached information for the particular destination server.

The database module 230 can also include a schema that defines the list of all compliance checks that are to be performed for a given destination server. An example of such a schema is provided below.

| Column Name | Description |
|---|---|
| COMPLIANCE_CHECK_ID | Primary key uniquely identifying the particular |
| | compliance check. |
| COMPLIANCE_CHECK_NAME | The name of the compliance check. |
| COMPLIANCE_CHECK_PLUGIN | Identification of the plug-in that is used to |
| | perform the specified compliance check. |
| COMPLIANCE_CHECK_TTL | TTL for the compliance check before check is |
| | considered stale and has to be performed again. |

In this example, the plug-in is the one or more modules that actually perform the necessary look-ups to determine compliance. As described below, these plug-ins can be added, deleted, and otherwise modified to account for new content and for new rules related to licensing or laws.

In some embodiments, a schema also exists for recording each compliance check within the database module 230. An example of such is provided below.

| Column Name | Description |
|---|---|
| DESTINATION_SERVER_ID | ID of the destination server. |
| COMPLIANCE_CHECK_ID | ID of the compliance check. |
| IS_COMPLIANT | TRUE/FALSE indicating whether |
| | or not the destination server is |
| | compliant with respect to |
| | the compliant check. |
| COMPLIANCE_CHECK_TIME | The time at which the compliance |
| | check was performed. |

As described further below, the information recorded by this schema can be used to statistically analyze the data gathered by the online compliance engine 120.

The database module 230 can also include a schema that defines the attributes associated with each licensed content. An example of such a schema is provided below.

| Column Name | Description |
|---|---|
| LICENSED_TECHNOLOGY_ID | Primary key uniquely identifying |
| | the content. |
| COMPLIANCE_CHECK_ID | Reference to the compliance |
| | check schema described above. |
| TECHNOLOGY_NAME | Name of the content. |
| TECHNOLOGY_OWNER | Name of the owner of the content. |
| IS_BILLABLE_PER_USE | TRUE/FALSE indicating whether |
| | or not the use of the content is |
| | billable per use. |

Further, the database module 230 can also include a schema that records each use of licensed content for statistical and billing purposes. An example of such a schema is provided below.

| Column Name | Description |
|---|---|
| LICENSED_SERV- | Primary key uniquely identifying the |
| ER_MAPPING_ID | mapping. |
| CLIENT_IP | IP address of the client that requested the |
| | content. |
| USAGE_TIME | Time at which the usage occurred. |
| IS_VALID_USE | TRUE/FALSE indicating whether or not |
| | the destination server was licensed to use |
| | the content. |
| IS_BILLED | TRUE/FALSE indicating whether or not |
| | the usage was billed. |
| LICENSED_TECHNOL- | Indicates the type of usage which occurred. |
| OGY_USAGE_TYPE_ID | |

In the example shown, the traditional DNS look-up and the compliance look-up are separate queries performed in parallel on separate database stores. In alternative embodiments, the two look-ups are combined such that a single query to a single database store provides both addressing and compliance information. For example, compliance information can be cached at the various DNS servers. Using a traditional DNS query, the compliance information can be passed to the online compliance engine 120 using the extension mechanisms provided in the DNS query system per RFC 2671. With such a configuration, the system 100 can be programmed to perform a DNS look-up even if the remote site is accessed directly using an IP address so that compliance information can be examined. Other configurations are possible.

Referring still to FIG. 2, once the compliance module 220 of the online compliance engine 120 determines whether or not the content requested from the destination server 140 is compliant, the compliance module 220 can return information to the client computing system 110 and/or the destination server 140. For example, as described further below, if the destination server 140 is found to be in compliance, the online compliance engine 120 allows the content to be delivered from the destination server 140 to the client computing system 110, and the billing module 260 can bill appropriately. Alternatively, if the compliance module 220 determines that the destination server 140 is not in compliance, the compliance module 220 can deliver a message to one or both of the client computing system 110 and the destination server 140 indicating the same. Also, the new license module 250 and the temporary license module 260 can communicate with the destination server 140 to license the content on the destination server 140, as described below.

If the destination server 140 is not in compliance, the new license module 240 of the online compliance engine 120 is programmed to offer licensing terms to the destination server 140. For example, the new license module 240 is programmed to offer licensing terms to the destination server 140 to allow the destination server 140 to distribute the desired content. Such terms, as described below, can include pre-paid, per-transaction, or unlimited transactions billing.

In addition, the temporary license module 250 is programmed to offer the destination server 140 a temporary license at a reduced fee or for no fee. For example, in one embodiment, the temporary license module 250 offers a set number of licensed transactions to the destination server 140 for no fee on a trial basis. The temporary license module 250 tracks the number of uses and communicates with the new license module 240 when the uses are exhausted to prompt the destination server 140 to purchase a license for the content.

If the destination server 140 signs up for a new license with the new license module 240 or a temporary license with the temporary license module 250, the compliance module 220 is programmed to then allow the requested content to be delivered from the destination server 140 to the client computing system 110.

In one alternative, the user of the client computing system 110 is also provided with an option to purchase a license so that the user can access the requested content. If the user purchases a license, the content is delivered to the user's client computing system 110 regardless of whether or not the destination server 140 is licensed to distribute the content. In some embodiments, the user can purchase a prepaid card that allows the user to purchase such licenses to obtain desired content.

In the example shown, the billing module 260 is programmed to bill the destination server 140 for the distribution of the licensed content. The billing can be done in real-time, such that billing information is recorded by the billing module 260 at the time of or shortly after each transaction occurs, or can be done in batches so that billing information is cached and periodically uploaded to the billing module 260. In the example shown, the billing module 260 is programmed to access records for billing information in the database module 230.

Generally, billing arrangements can be made to bill periodically based on usage, or can be billed on a pre-paid basis or on a bulk or unlimited basis. As described below, trial licenses can also be provided for a fee or for no fee. Billing can also be dependent on other factors such as amount of usage, time of day, geographic region of access, etc. The billing module 260 can be programmed to accept various forms of payment including credit or debit cards, online wire transfers, and Paypal.

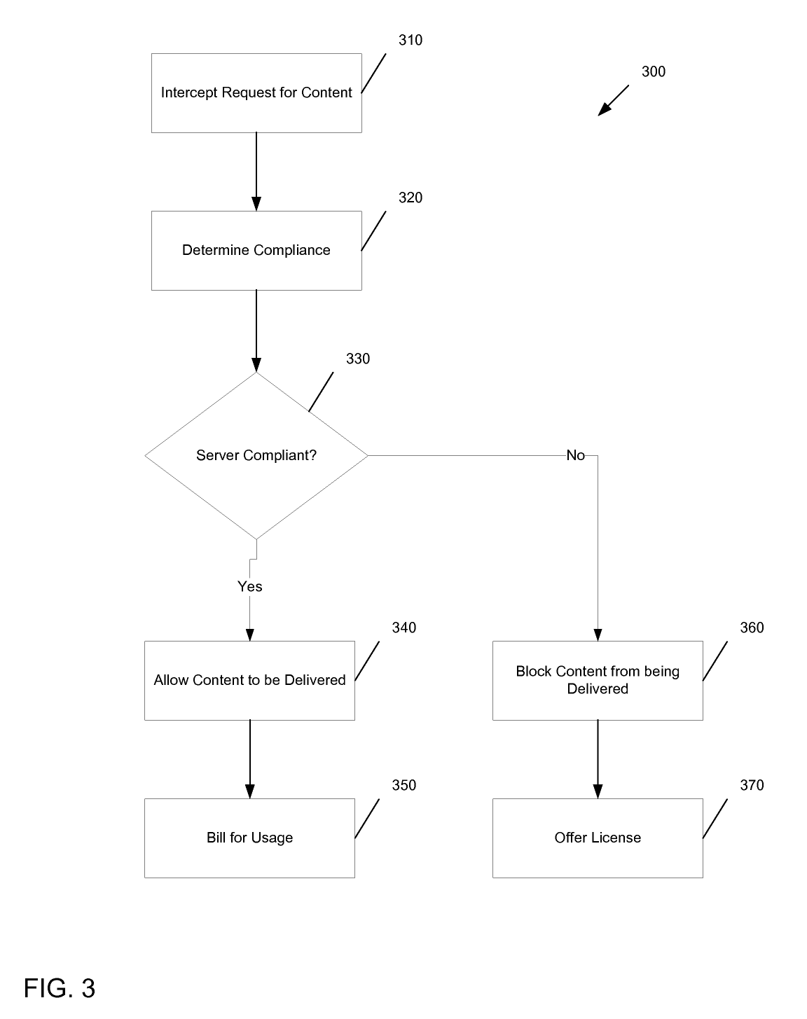

Referring now to FIG. 3, an example method 300 for restricting content that is distributed online using the online compliance engine is shown. Initially, at operation 310, the user's request for content from a remote server is intercepted. For example, a user can request a video hosted on a destination server using a web browser on the user's computer. This request is intercepted by the online compliance engine.

Next, at operation 320, the online compliance engine performs one or more queries to determine whether or not the destination server that is hosting the content is compliant. This can include querying a database to determine if the destination server is licensed to distribute the requested content. For example, the online compliance engine queries a compliance database to see if the destination server is licensed by the owner of the intellectual property associated with the requested video to distribute the requested video to the user.

Next, at operation 330, the online compliance engine determines whether or not the destination server is compliant. If so, control is passed to operation 340 and the content is allowed to be delivered to the user. Next, at operation 350, the destination server can be billed for the distribution of the content. For example, if the destination server is licensed to distribute the video, the video is delivered to the user, and the destination server is billed for the distribution of the video.

Alternatively, if at operation 330 the online compliance engine determines that the destination server is not compliant, control is passed to operation 360 and the content is blocked from being delivered to the user. Next, at operation 370, the destination server is offered a license to allow the destination server to distribute the content. For example, if the destination server is not licensed to distribute the video, the video is blocked from being delivered to the user. Also, the destination server is offered a license to allow the destination server to distribute the video.

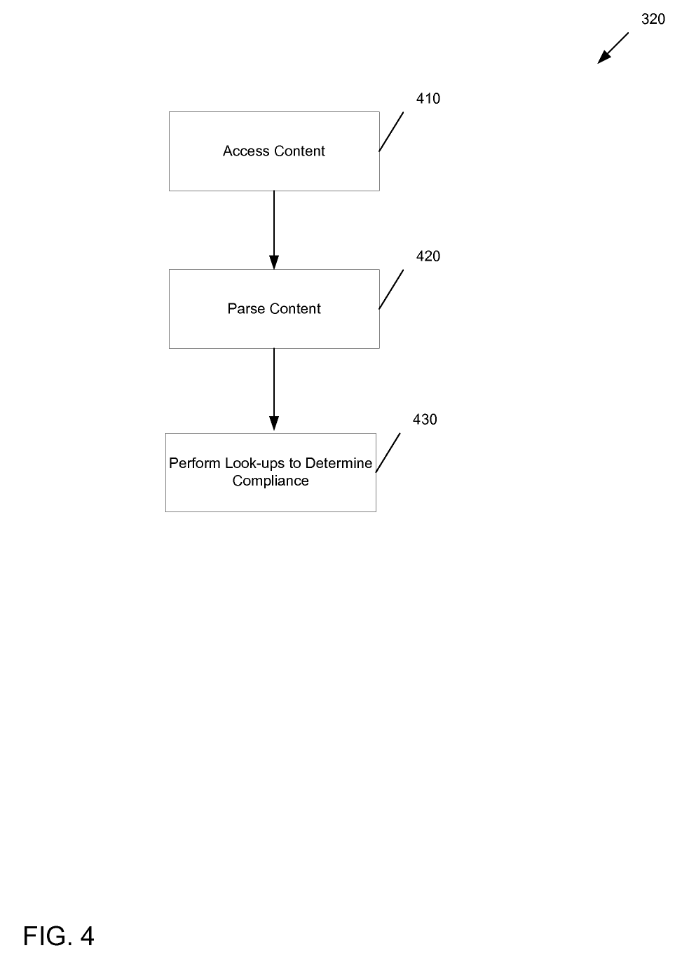

Referring now to FIG. 4, additional details regarding the operation 320 for determining compliance is shown. At operation 410, the content that was requested by the user is accessed by the online compliance engine. Next, at operation 420, the content is parsed automatically to identify any portion of the content that would be protected by intellectual property interests and subject to licensing.

In example embodiments, the content can be parsed in various manners. For example, the online compliance engine can maintain one or more databases with tables of IP or domain names of licensed sites. In other examples, the online compliance engine can be programmed to automatically parse the content of the site to identify intellectual property related to content such as videos, songs, text, logos, and other branding. Each piece of intellectual property that is identified can then be checked for proper licensing.

In other examples, the content itself can be tagged with licensing information such that the online compliance engine can verify licensing information based on the tags. In yet other examples, entire sites can be “pre-verified” by registering with a central content verification system. Registration with the central content verification system allows the site to be certified as compliant with licensing so that the online compliance engine simply allows content from the verified site to be delivered to the requester without requiring further look-ups. In yet

Finally, at operation 430, look-ups are performed to determine whether or not the destination site is compliant and has the proper licensing to distribute the content. In one example, the online compliance engine is programmed to block content if a determination of licensing cannot be made. In yet another embodiment, the online compliance engine is programmed to allow content to be distributed if a determination of licensing cannot be made.

In an alternative embodiment, the operation 420 of parsing the content can be done manually, as opposed to automatically. For example, the intellectual property owner can be contacted and allowed to review the content from the destination server before the destination server is found to be in compliance and allowed to deliver the content. Other configurations are possible.

As mentioned previously, the online compliance engine 120 can be located at various positions within the architecture of the system 100. For example, referring now to FIG. 5, in an alternative system 500, the online compliance engine 120 is located on the client computing system 110. In this embodiment, the online compliance engine 120 can be a stand alone application installed on the client computing system 110, or can be a plug-in for an application such as the web browser running on the client computing system 110. In this embodiment, the online compliance engine 120 functions as an agent on the client computing system 110 such that all requests for content are controlled by and routed through the online compliance engine 120. In this manner, the online compliance engine 120 can control when a request is made, intercept the request, make the necessary determinations as to whether or not the destination server is in compliance, and allow or block delivery of the content accordingly. In such an embodiment, a local cache of compliance information can be saved on the client computing system 110, or the online compliance engine 120 can query one or more online databases available through the network 130 to determine compliance.

Referring now to FIG. 6, in another alternative embodiment of a system 600, the online compliance engine 120 is located on the destination server 140. In such an embodiment, all requests for content from the destination server 140 are routed through the online compliance engine 120. The online compliance engine 120 can cache compliance information for a period of time to allow content to be delivered without requiring queries for compliance for each request. The online compliance engine 120 can be programmed to periodically refresh the cache to assure compliance by the destination server 140. If the destination server 140 fails to be compliant, the online compliance engine 120 blocks the destination server 140 from distributing content that is not in compliance.

In the examples described above, the online compliance engine is used to check for compliance with licenses associated with the distribution of content subject to intellectual property interests. However, in alternative embodiments, the online compliance engine can be used to perform other filtering functions as well.

For example, the online compliance engine can be used to filter content based on other laws associated with the geographic area in which the requesting party is located. In such an example, the requesting user location is determined, and the online compliance engine is used to filter content that can be delivered by the destination server based on the laws of the location of the user or the destination server. For example, some content that is distributed online is restricted by US export laws. The online compliance engine can be used to filter requests from users located outside the US and to block the distribution of content to those users should such distributions violate the export laws. In another example, US laws regulate gambling that is done on off-shore gambling sites. The online compliance engine can be used to filter and limit such access to such gambling based on US law.

In other embodiments, the online compliance engine is programmed to assist in the verification of the identity of the destination server so that online fraud issues such as spoofing or phishing can be reduced. In such examples, the online compliance engine intercepts the content request and then queries the destination server to verify the identity of the destination server. Other configurations are possible.

In some embodiments, the online compliance engine also collects and organizes statistics about requests and compliance. Such statistics can be used, for example, for trending users' web surfing histories, since the online compliance engine intercepts all traffic from the client to the Internet. These statistics can be used, for example, for advertising or other research purposes.

Various modifications and alterations of this disclosure will become apparent to those skilled in the art without departing from the scope and spirit of this disclosure, and it should be understood that the inventive scope of this disclosure is not to be unduly limited to the illustrative embodiments set forth herein.

What is claimed is:

1. An online compliance engine stored on a computer readable storage medium, the engine comprising:
an intercept module programmed to intercept a request by a client for content on a destination server;
a compliance module programmed to access and parse the content from the destination server requested by the client, and to determine whether or not the destination server is authorized to distribute the content, the compliance module being further programmed to allow the destination server to distribute the content to the client if the destination server is compliant, and to block the destination server from distributing the content if the destination server is not compliant; and
a billing module programmed to bill the destination server if the content is distributed to the client.

2. The engine of claim 1, wherein the request is a request from a browser of the client.

3. The engine of claim 1, wherein the compliance module is programmed to determine whether or not the destination server is licensed to distribute the content.

4. The engine of claim 1, wherein the compliance module is programmed to determine whether or not the destination server is authorized to distribute the content based on laws associated with a geographic location of the client or the destination server.

5. The engine of claim 1, further comprising a database module programmed to store compliance information, the database module being distributed across multiple instances.

6. The engine of claim 1, wherein the engine is positioned between the client and the network.

7. The engine of claim 1, wherein the compliance module is programmed to notify the destination server if the destination server is blocked from distributing the content.

8. The engine of claim 7, further comprising a new license module programmed to offer the destination server a license to distribute the content if the destination server is blocked from distributing the content.

9. A method for controlling content distributed through a network, the method comprising:
intercepting a request for content sent from a client to a server;
accessing the content requested by the client;
parsing the content to identify portions subject to restrictions on distribution;
determining the server's compliance with distribution of the portions subject to restriction of distribution;
allowing the server to distribute the content to the client if the server is compliant; and
blocking the server from distributing the content to the client if the server is not compliant.

10. The method of claim 9, wherein the restrictions are associated with intellectual property interests associated with the content.

11. The method of claim 10, further comprising billing the server for the distribution of the content.

12. The method of claim 9, further comprising billing the server for the distribution of the content.

13. The method of claim 9, further comprising offering to license the server so that the server is compliant.

14. The method of claim 9, further comprising querying one or more compliance databases to determine if the server is compliant.

15. The method of claim 14, further comprising using the Internet Protocol address of the server to query the databases.

16. A method for controlling content distributed through the Internet, the method comprising:
positioning a compliance and billing engine between a client and the Internet, the compliance and billing engine filtering all requests sent by the client through the Internet;
intercepting a request for content sent from the client to a server;
accessing the content requested by the client;
parsing the content to identify portions subject to restrictions on distribution;
determining the server's compliance with distribution of the portions subject to restriction of distribution based on intellectual property interests;
allowing the server to distribute the content to the client if the server is compliant, and billing the server for the distribution of the content; and
blocking the server from distributing the content to the client if the server is not compliant, and offering to license the server so that the server is compliant.

17. The method of claim 16, further comprising querying one or more compliance databases to determine if the server is compliant.

18. The method of claim 16, further comprising using the Internet Protocol address of the server to query the databases.
